(19) United States
(12) Patent Application Publication
(10) Pub. No.: US 2012/0033136 A1
(43) Pub. Date: Feb. 9, 2012

(54) FILM-ORIGINATED VIDEO REGION DETECTION METHOD

(75) Inventor: Satoru TANIGAWA, Hyogo (JP)

(73) Assignee: Panasonic Corporation, Osaka (JP)

(21) Appl. No.: 13/271,799

(22) Filed: Oct. 12, 2011

Related U.S. Application Data
(63) Continuation of application No. PCT/JP2009/005127, filed on Oct. 2, 2009.

(30) Foreign Application Priority Data
May 29, 2009 (JP) 2009-130630

(51) Int. Cl. H04N 5/14

(52) U.S. Cl. 348/571; 348/E05.062

(57) ABSTRACT

Film-originated video detection is performed on an input video signal in each of regions into which an entire screen is divided. Based on the detection result, a case where there is not film-originated video is separated from a case where film-originated video covers the entire screen. When both a film region and a non-film region are contained, film-originated video detection is performed in sub-regions into which a region which has been determined to be a film region is subdivided. Based on the detection result, it is determined whether or not all the sub-regions are film regions. The determination is repeatedly performed until it is determined that all sub-regions are film regions. If it is determined that all sub-regions are film regions, a film-originated video region is determined, and the process is ended. Thus, a film-originated video region can be accurately detected in a screen containing film-originated video and non-film-originated video.

### CROSS-REFERENCE TO RELATED APPLICATIONS

This is a continuation of PCT International Application PCT/JP2009/005127 filed on Oct. 2, 2009, which claims priority to Japanese Patent Application No. 2009-130630 filed on May 29, 2009. The disclosures of these applications including the specifications, the drawings, and the claims are hereby incorporated by reference in their entirety.

### BACKGROUND

The present disclosure relates to film-originated video region detection methods for use in television sets etc. when a film-originated video signal is input.

In recent years, television sets employing liquid crystal display devices, plasma display devices, etc. have been acquiring an increasing screen and resolution, and in this situation, it is of great importance to display video having higher image quality. To this end, emphasis is placed on video processing in which interlaced-to-progressive scan conversion, frame rate conversion, noise reduction, contour correction, etc. are performed, depending on the state of an input video signal.

Displaying of a film-originated video signal produced by 2-3 pulldown has become more common. It is contemplated that the film-originated video signal is detected, and the interlaced signal is converted into a non-interlaced signal. There is also an increasing demand for film-originated video having higher image-quality, and emphasis is placed on a video processing technique suited to film-originated video.

Moreover, there are increasing occasions when a plurality of screens are simultaneously displayed (for example, film-originated video, and a normal broadcast or a program table other than the film-originated video, are displayed). It is important to correctly determine the boundary between film-originated video and other signals or the region of film-originated video.

For example, in a conventional film-originated video detection method, a screen division section divides an input image into a plurality of blocks, and a feature amount calculation section calculates a feature amount of each block. The feature amount is the sum of the absolute values of the differences between pixel values in one block and pixel values in another block located two fields before. A determination section determines whether or not the feature amount of each block exceeds a threshold. A repeated field comprehensive determination section determines that a field is not a repeated field if there is at least one block in which the determination result of the determination section exceeds the threshold (see Japanese Patent Publication No. 2004-201010 (FIG. 3)).

The above conventional film-originated video detection method can detect whether or not subtitles are contained in a material in which a 2-3 pulldown material is combined with subtitle images, but cannot accurately detect a boundary portion between the 2-3 pulldown material and a normal material (e.g., subtitles etc.) or the size of a film-originated video region. Also, there is not a conventional technique of switching between a signal process for film-originated video and a signal process for normal video, depending on the region, by detecting a boundary portion between a film material and a normal material to detect a film-originated video region.

### SUMMARY

The present disclosure describes implementations of a film-originated video region detection method with improved accuracy of detection of a film-originated video region, and the use of the film-originated video region detection method to improve the image quality of a television set.

According to the present disclosure, for example, in the case of 2-3 pulldown film-originated video, film-originated video detection is performed by utilizing the fact that the same signal is transmitted once every five fields. Initially, film-originated video detection is performed in each of regions into which an entire screen is divided. Based on the detection result, a film-originated video region is determined. Here, a region which has been determined to be a film-originated video region is subdivided, and film-originated video detection is performed in each of the resulting sub-regions. Based on the detection result, a film-originated video region is determined with higher precision. A film-originated video region can be more accurately detected by repeatedly performing a similar film detection step and region determination step. The improvement of the detection precision of a film-originated video region allows switching between a video process for film-originated video regions and a video process for other regions, resulting in an improvement in image quality.

Note that the region determination step of determining a film-originated video region may be replaced with a step of determining a non-film-originated video region. In this case, by specifying a non-film-originated video region, a film-originated video region can be consequently detected with high accuracy.

According to the present disclosure, for example, in the case of 2-3 pulldown, film-originated video is detected in each of a plurality of division regions based on the fact that the same video signal is transmitted, and a region which has been determined to be a film-originated video region is subdivided, and film-originated video is detected in the resulting sub-regions, whereby a film-originated video region can be accurately specified, and therefore, the precision of detection of a size and boundary of a film-originated video region can be improved.

A screen is initially divided into large regions, in which film-originated video detection is performed. A film-originated video region is successively narrowed, whereby a failure of detection of a film-originated video region is reduced or prevented, and therefore, a film-originated video region can be accurately detected. Moreover, the narrowing of the region may be performed from a region larger than a region which has been determined to be a film-originated video region, or a film-originated video region may be changed horizontally or vertically, whereby the detection precision can be improved.

By applying the film-originated video region detection method to video signal processing to switch between a process or settings for film-originated video and a process or settings for normal video, each type of video can be processed by an appropriate process or settings, resulting in an improvement in image quality.

### BRIEF DESCRIPTION OF THE DRAWINGS

FIG. 1 is a flowchart showing a film-originated video region detection method according to a first embodiment of the present disclosure.

FIGS. 2A-2C are conceptual diagrams showing a screen division procedure in the film-originated video region detection method of the first embodiment of the present disclosure.

FIG. 3 is a flowchart showing a film-originated video region detection method according to a second embodiment of the present disclosure.

FIG. 4 is a flowchart showing a film-originated video region detection method according to a third embodiment of the present disclosure.

FIG. 5 is a flowchart showing a film-originated video region detection method according to a fourth embodiment of the present disclosure.

FIGS. 6A-6C are conceptual diagrams showing a screen division procedure in the film-originated video region detection method of the fourth embodiment of the present disclosure.

FIG. 7 is a flowchart showing a film-originated video region detection method according to a fifth embodiment of the present disclosure.

FIG. 8 is a flowchart showing a film-originated video region detection method according to a sixth embodiment of the present disclosure.

FIG. 9 is a flowchart showing a film-originated video region detection method according to a seventh embodiment of the present disclosure.

FIG. 10 is a flowchart showing a film-originated video region detection method according to an eighth embodiment of the present disclosure.

FIG. 11 is a flowchart showing a film-originated video region detection method according to a ninth embodiment of the present disclosure.

FIG. 12 is a flowchart showing a film-originated video region detection method according to a tenth embodiment of the present disclosure.

FIG. 13 is a flowchart showing a film-originated video region detection method according to an eleventh embodiment of the present disclosure.

FIG. 14 is a flowchart showing a film-originated video region detection method according to a twelfth embodiment of the present disclosure.

### DETAILED DESCRIPTION

Embodiments of the present disclosure will be described in detail hereinafter with reference to the accompanying drawings.

### First Embodiment

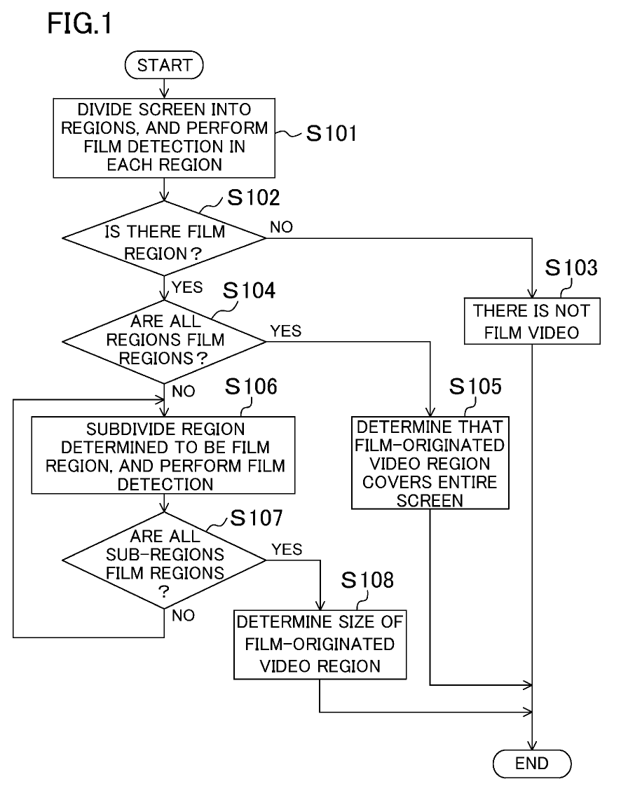

FIG. 1 is a flowchart showing a film-originated video region detection method according to a first embodiment of the present disclosure. In FIG. 1, in step S101, film detection (detection of film-originated video) is performed on an input video signal in each of a plurality of regions into which a screen is divided. In step S102, based on the detection result, it is determined whether or not there is a film region. If it is determined that there is not a film region, it is determined that there is not film-originated video (step S103). If it is determined that there is film-originated video, it is determined whether or not all the regions are film regions in step S104. If it is determined that all the regions are film regions, it is determined that film-originated video covers the entire screen (step S105). If there is a region which is not a film region, in step S106 a region which has been determined to be a film region is subdivided, and film detection (film-originated video detection) is performed in the resulting sub-regions. In step S107, based on the result of step S106, it is determined whether or not all the sub-regions are film regions. The determination of step S107 is repeatedly performed until it is determined that all sub-regions are film regions. If it is determined that all sub-regions are film regions, a film-originated video region is determined (step S108), and the process is ended.

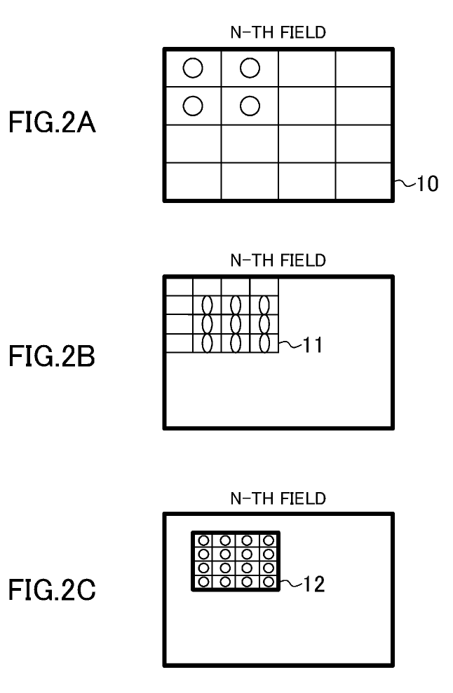

FIGS. 2A-2C are conceptual diagrams showing screens divided based on the flowchart of FIG. 1. In FIG. 2A, input video is divided over an entire screen 10, film-originated video detection is performed in each division region, and regions which it has been determined that are film regions are indicated by circles. In FIG. 2B, a film region 11 of FIG. 2A is subdivided, film-originated video detection is performed, and sub-regions which it has been determined that are film regions are indicated by circles. In FIG. 2C, a film region 12 of FIG. 2B is subdivided, film-originated video detection is performed, sub-regions which it has been determined that are film regions are indicated by circles. The process is repeatedly performed until it is determined that all sub-regions are film-originated video regions.

Note that even if the order of processing of step S102 of determining whether or not there is a film region and step S104 of determining whether or not all regions are film regions may be rearranged (i.e., step S104 may be performed before step S102), a similar advantage is obtained. Such a step rearrangement may be effective in embodiments described below.

If it is desired to detect rough regions, the process may be ended after being repeatedly performed an integral number of times before film-originated video detection is performed on all regions.

### Second Embodiment

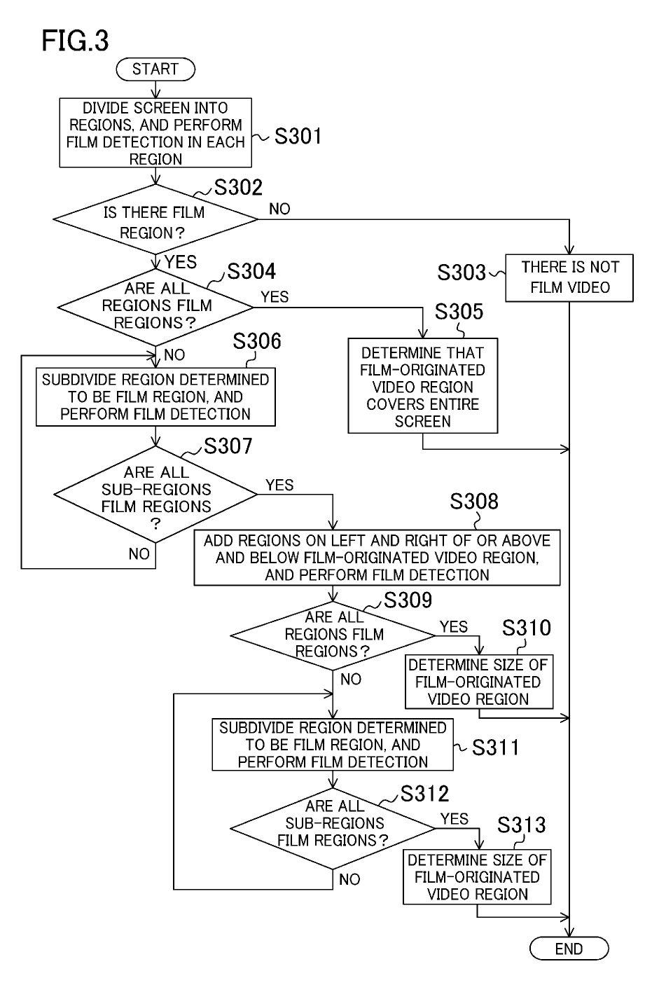

FIG. 3 is a flowchart showing a film-originated video region detection method according to a second embodiment of the present disclosure. In FIG. 3, in step S301, film detection (detection of film-originated video) is performed on an input video signal in each of a plurality of regions into which a screen is divided. In step S302, based on the detection result, it is determined whether or not there is a film region. If it is determined that there is not a film region, it is determined that there is not film-originated video (step S303). If it is determined that there is film-originated video, it is determined whether or not all the regions are film regions in step S304. If it is determined that all the regions are film regions, it is determined that film-originated video covers the entire screen (step S305). If there is a region which is not a film region, in step S306 a region which has been determined to be a film region is subdivided, and film detection (film-originated video detection) is performed in the resulting sub-regions. In step S307, based on the result of step S306, it is determined whether or not all the sub-regions are film regions. The determination of step S307 is repeatedly performed until it is determined that all sub-regions are film regions. If it is determined that all sub-regions are film regions, in step S308 regions located on the left and right of or above and below the film-originated video region are added to the film-originated video region, and film-originated video detection is performed. In step S309, based on the result of step S308, it is determined whether or not all the regions are film regions. If it is determined that all the regions are film regions, a film-originated video region is determined in step S310. If there is a region which is not a film region, in step S311 a region which has been determined to be a film region is subdivided, and film detection (film-originated video detection) is performed in the resulting sub-regions. In step S312, based on the result of step S311, it is determined whether or not all the sub-regions are film regions. The determination of step S312 is repeatedly performed until it is determined that all sub-regions are film regions. If it is determined that all sub-regions are film regions, a film-originated video region is determined (step S313), and the process is ended.

### Third Embodiment

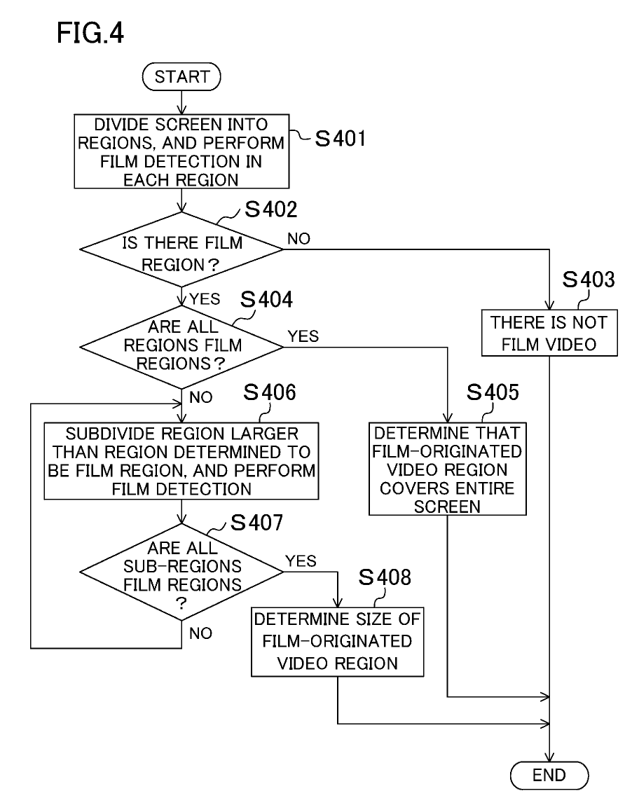

FIG. 4 is a flowchart showing a film-originated video region detection method according to a third embodiment of the present disclosure. In FIG. 4, in step S401, film detection (detection of film-originated video) is performed on an input video signal in each of a plurality of regions into which a screen is divided. In step S402, based on the detection result, it is determined whether or not there is a film region. If it is determined that there is not a film region, it is determined that there is not film-originated video (step S403). If it is determined that there is film-originated video, it is determined whether or not all the regions are film regions in step S404. If it is determined that all the regions are film regions, it is determined that film-originated video covers the entire screen (step S405). If there is a region which is not a film region, in step S406 a periphery of a region which has been determined to be a film region is expanded, the expanded region is subdivided, and film detection (film-originated video detection) is performed in the resulting sub-regions. In step S407, based on the result of step S406, it is determined whether or not all the sub-regions are film regions. The determination of step S407 is repeatedly performed until it is determined that all sub-regions are film regions. If it is determined that all sub-regions are film regions, a film-originated video region is determined (step S408), and the process is ended.

### Fourth Embodiment

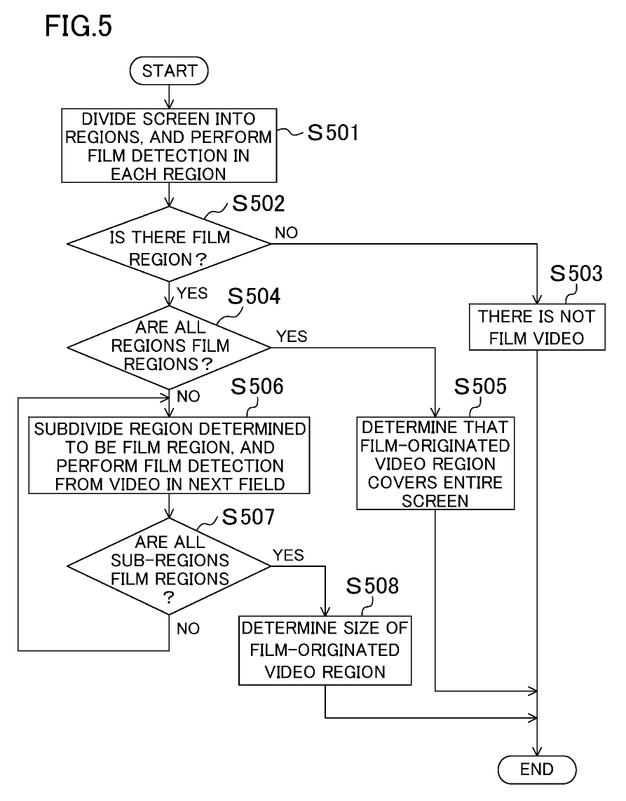

FIG. 5 is a flowchart showing a film-originated video region detection method according to a fourth embodiment of the present disclosure. In FIG. 5, in step S501, film detection (detection of film-originated video) is performed on an input video signal in each of a plurality of regions into which a screen is divided. In step S502, based on the detection result, it is determined whether or not there is a film region. If it is determined that there is not a film region, it is determined that there is not film-originated video (step S503). If it is determined that there is film-originated video, it is determined whether or not all the regions are film regions in step S504. If it is determined that all the regions are film regions, it is determined that film-originated video covers the entire screen (step S505). If there is a region which is not a film region, in step S506 a region which has been determined to be a film region is subdivided in the next field or frame, and film detection (film-originated video detection) is performed in the resulting sub-regions. In step S507, based on the result of step S506, it is determined whether or not all the sub-regions are film regions. The determination of step S507 is repeatedly performed until it is determined that all sub-regions are film regions. If it is determined that all sub-regions are film regions, a film-originated video region is determined (step S508), and the process is ended.

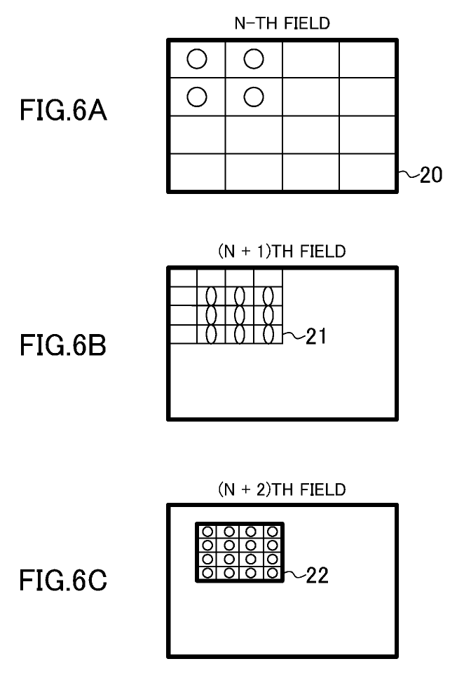

FIGS. 6A-6C are conceptual diagrams showing screens divided based on the flowchart of FIG. 5. In FIG. 6A, input video is divided over an entire screen 20, film-originated video detection is performed in each division region, and regions which it has been determined that are film regions are indicated by circles. In FIG. 6B, a film region 21 of FIG. 6A is subdivided in the next field or frame, film-originated video detection is performed, and sub-regions which it has been determined that are film regions are indicated by circles. In FIG. 6C, a film region 22 of FIG. 6B is subdivided in the next field or frame, film-originated video detection is performed, sub-regions which it has been determined that are film regions are indicated by circles. The process is repeatedly performed until it is determined that all sub-regions are film-originated video regions.

### Fifth Embodiment

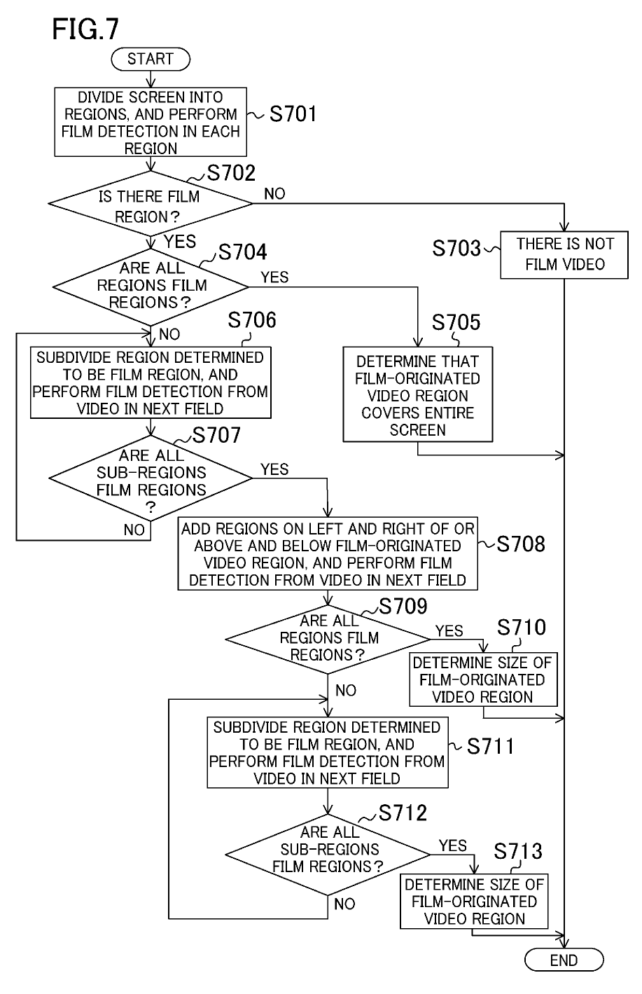

FIG. 7 is a flowchart showing a film-originated video region detection method according to a fifth embodiment of the present disclosure. In FIG. 7, in step S701, film detection (detection of film-originated video) is performed on an input video signal in each of a plurality of regions into which a screen is divided. In step S702, based on the detection result, it is determined whether or not there is a film region. If it is determined that there is not a film region, it is determined that there is not film-originated video (step S703). If it is determined that there is film-originated video, it is determined whether or not all the regions are film regions in step S704. If it is determined that all the regions are film regions, it is determined that film-originated video covers the entire screen (step S705). If there is a region which is not a film region, in step S706 a region which has been determined to be a film region is subdivided in the next field or frame, and film detection (film-originated video detection) is performed in the resulting sub-regions. In step S707, based on the result of step S706, it is determined whether or not all the sub-regions are film regions. The determination of step S707 is repeatedly performed until it is determined that all sub-regions are film regions. If it is determined that all the sub-regions are film regions, regions located on the left and right of or above and below the film-originated video region are added to the film-originated video region in the next field or frame, and film-originated video detection is performed (step S708). In step S709, based on the result of step S708, it is determined whether or not all the regions are film regions. If it is determined that all the regions are film regions, a film-originated video region is determined (step S710). If there is a region which is not a film region, in step S711 a region which has been determined to be a film region is subdivided in the next field or frame, and film detection (film-originated video detection) is performed in the resulting sub-regions. In step S712, based on the result of step S711, it is determined whether or not all the sub-regions are film regions. The determination of step S712 is repeatedly performed until it is determined that all sub-regions are film regions. If it is determined that all sub-regions are film regions, a film-originated video region is determined (step S713), and the process is ended.

### Sixth Embodiment

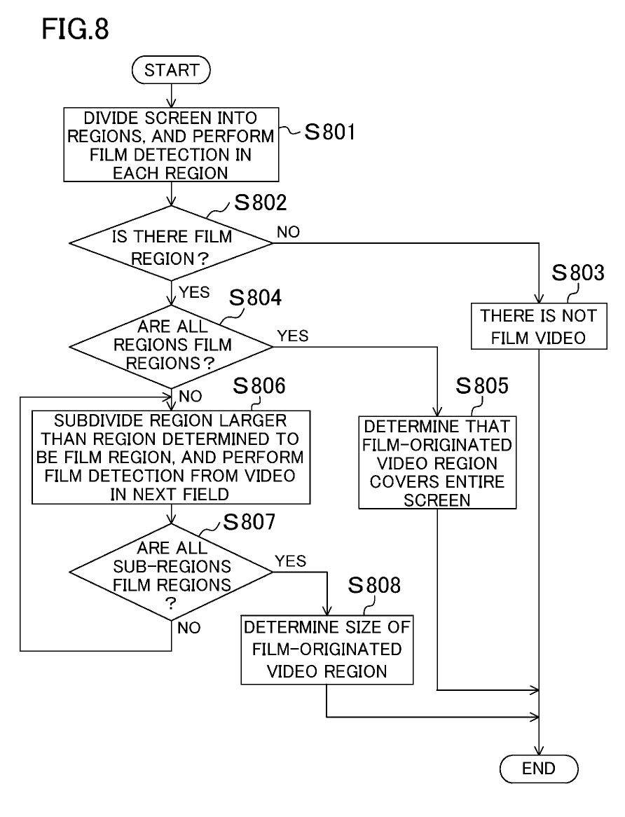

FIG. 8 is a flowchart showing a film-originated video region detection method according to a sixth embodiment of the present disclosure. In FIG. 8, in step S801, film detection (detection of film-originated video) is performed on an input video signal in each of a plurality of regions into which a screen is divided. In step S802, based on the detection result, it is determined whether or not there is a film region. If it is determined that there is not a film region, it is determined that there is not film-originated video (step S803). If it is determined that there is film-originated video, it is determined whether or not all the regions are film regions in step S804. If it is determined that all the regions are film regions, it is determined that film-originated video covers the entire screen (step S805). If there is a region which is not a film region, in step S806 a periphery of a region which has been determined to be a film region is expanded in the next field or frame, the expanded region is subdivided, and film detection (film-originated video detection) is performed in the resulting sub-regions. In step S807, based on the result of step S806, it is determined whether or not all the sub-regions are film regions. The determination of step S807 is repeatedly performed until it is determined that all sub-regions are film regions. If it is determined that all sub-regions are film regions, a film-originated video region is determined (step S808), and the process is ended.

### Seventh Embodiment

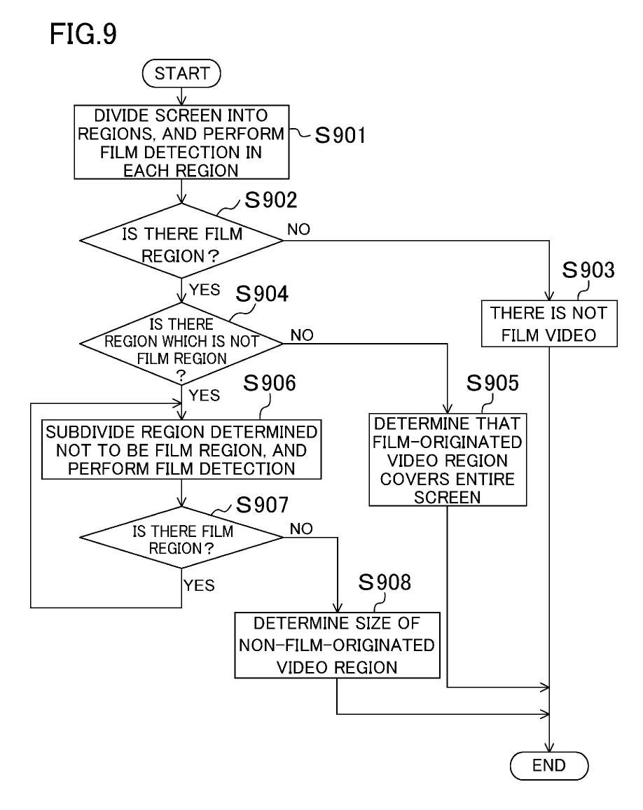

FIG. 9 is a flowchart showing a film-originated video region detection method according to a seventh embodiment of the present disclosure. In FIG. 9, in step S901, film detection (detection of film-originated video) is performed on an input video signal in each of a plurality of regions into which a screen is divided. In step S902, based on the detection result, it is determined whether or not there is a film region. If it is determined that there is not a film region, it is determined that there is not film-originated video (step S903). If it is determined that there is film-originated video, it is determined whether or not there is a region which is not a film region in step S904. If it is determined that all the regions are film regions, it is determined that film-originated video covers the entire screen (step S905). If there is a region which is not a film region, in step S906 a region which has been determined not to be a film region is subdivided, and film detection (film-originated video detection) is performed in the resulting sub-regions. In step S907, based on the result of step S906, it is determined whether or not there is a film region. The determination of step S907 is repeatedly performed until it is determined that none of sub-regions is a film region. If it is determined that none of sub-regions is a film region, a non-film-originated video region is determined (step S908), and the process is ended.

### Eighth Embodiment

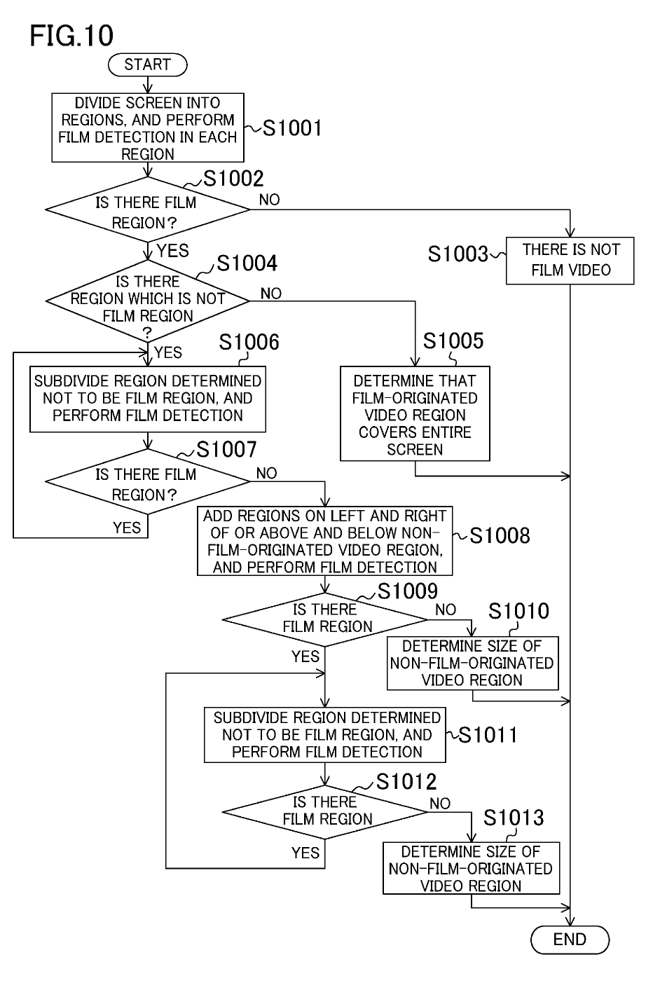

FIG. 10 is a flowchart showing a film-originated video region detection method according to an eighth embodiment of the present disclosure. In FIG. 10, in step S1001, film detection (detection of film-originated video) is performed on an input video signal in each of a plurality of regions into which a screen is divided. In step S1002, based on the detection result, it is determined whether or not there is a film region. If it is determined that there is not a film region, it is determined that there is not film-originated video (step S1003). If it is determined that there is film-originated video, it is determined whether or not there is a region which is not a film region in step S1004. If it is determined that all the regions are film regions, it is determined that film-originated video covers the entire screen (step S1005). If there is a region which is not a film region, in step S1006 a region which has been determined not to be a film region is subdivided, and film detection (film-originated video detection) is performed in the resulting sub-regions. In step S1007, based on the result of step S1006, it is determined whether or not there is a film region. The determination of step S1007 is repeatedly performed until it is determined that none of sub-regions is a film region. If it is determined that none of sub-regions is a film region, regions located on the left and right of or above and below the non-film-originated video region are added to the non-film-originated video region, and film-originated video detection is performed (step S1008). In step S1009, based on the result of step S1008, it is determined whether or not there is a film region. If it is determined that none of the regions is a film region, a non-film-originated video region is determined (step S1010). If there is a film region, in step S1011 a region which has been determined not to be a film region is subdivided, and film detection (film-originated video detection) is performed in the resulting sub-regions. In step S1012, based on the result of step S1011, it is determined whether or not there is a film region. The determination of step S1012 is repeatedly performed until it is determined that none of sub-regions is a film region. If it is determined that none of sub-regions is a film region, a non-film-originated video region is determined (step S1013), and the process is ended.

### Ninth Embodiment

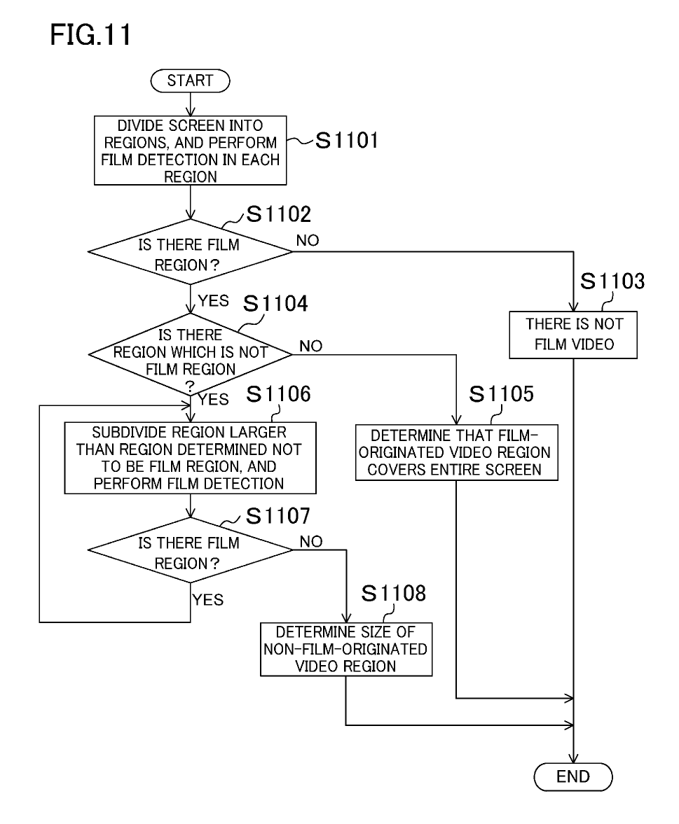

FIG. 11 is a flowchart showing a film-originated video region detection method according to a ninth embodiment of the present disclosure. In FIG. 11, in step S1101, film detection (detection of film-originated video) is performed on an input video signal in each of a plurality of regions into which a screen is divided. In step S1102, based on the detection result, it is determined whether or not there is a film region. If it is determined that there is not a film region, it is determined that there is not film-originated video (step S1103). If it is determined that there is film-originated video, it is determined whether or not there is a region which is not a film region in step S1104. If it is determined that all the regions are film regions, it is determined that film-originated video covers the entire screen (step S1105). If there is a region which is not a film region, in step S1106 a periphery of a region which has been determined not to be a film region is expanded, the expanded region is subdivided, and film detection (film-originated video detection) is performed in the resulting sub-regions. In step S1107, based on the result of step S1106, it is determined whether or not there is a film region. The determination of step S1107 is repeatedly performed until it is determined that none of sub-regions is a film region. If it is determined that none of sub-regions is a film region, a non-film-originated video region is determined (step S1108), and the process is ended.

### Tenth Embodiment

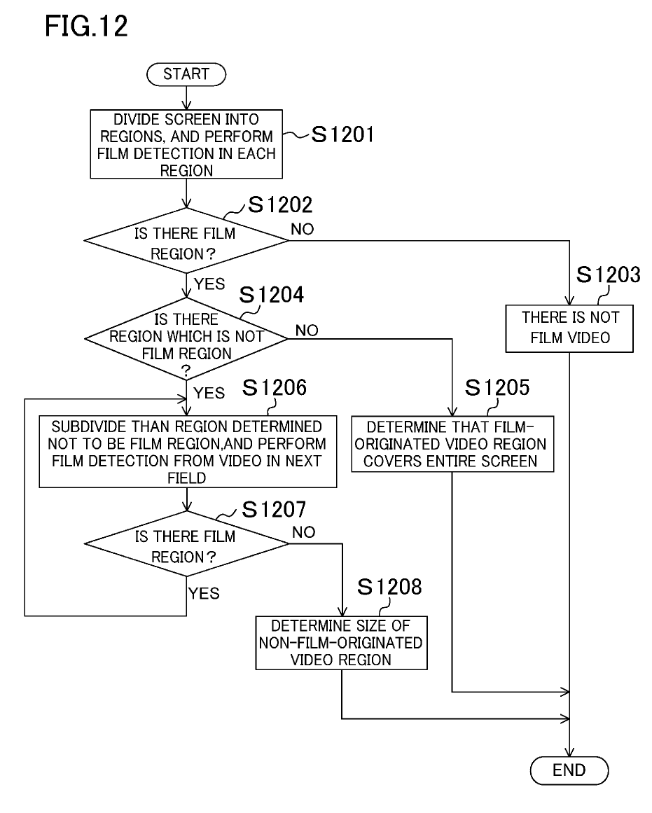

FIG. 12 is a flowchart showing a film-originated video region detection method according to a tenth embodiment of the present disclosure. In FIG. 12, in step S1201, film detection (detection of film-originated video) is performed on an input video signal in each of a plurality of regions into which a screen is divided. In step S1202, based on the detection result, it is determined whether or not there is a film region. If it is determined that there is not a film region, it is determined that there is not film-originated video (step S1203). If it is determined that there is film-originated video, it is determined whether or not there is a region which is not a film region in step S1204. If it is determined that all the regions are film regions, it is determined that film-originated video covers the entire screen (step S1205). If there is a region which is not a film region, in step S1206 a region which has been determined not to be a film region is subdivided in the next field or frame, and film detection (film-originated video detection) is performed in the resulting sub-regions. In step S1207, based on the result of step S1206, it is determined whether or not there is a film region. The determination of step S1207 is repeatedly performed in a plurality of fields or frames until it is determined that none of sub-regions is a film region. If it is determined that none of sub-regions is a film region, a non-film-originated video region is determined (step S1208), and the process is ended.

### Eleventh Embodiment

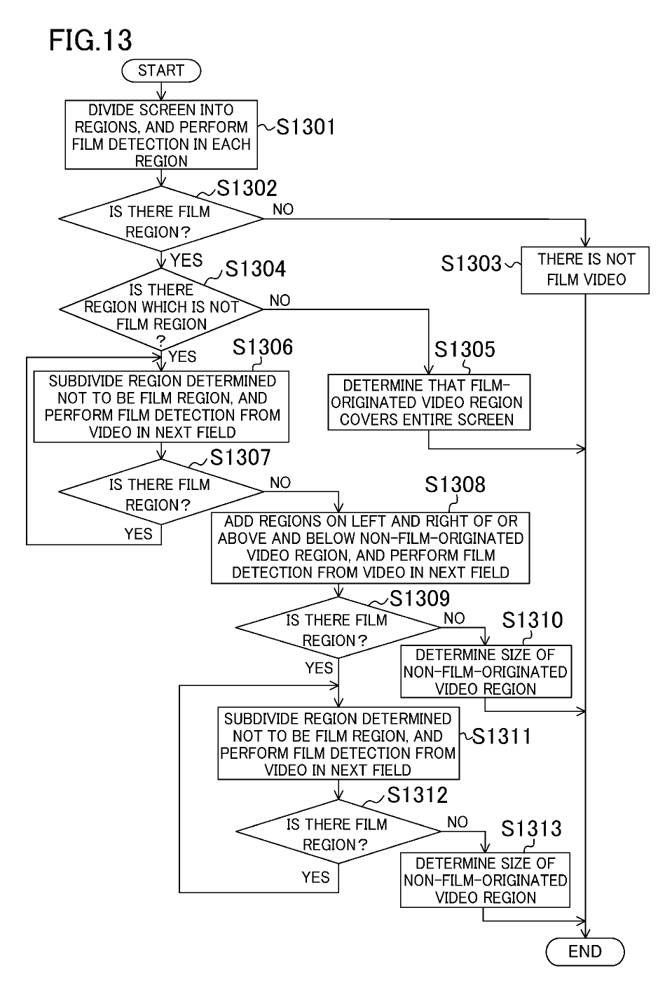

FIG. 13 is a flowchart showing a film-originated video region detection method according to an eleventh embodiment of the present disclosure. In FIG. 13, in step S1301, film detection (detection of film-originated video) is performed on an input video signal in each of a plurality of regions into which a screen is divided. In step S1302, based on the detection result, it is determined whether or not there is a film region. If it is determined that there is not a film region, it is determined that there is not film-originated video (step S1303). If it is determined that there is film-originated video, it is determined whether or not there is a region which is not a film region in step S1304. If it is determined that all the regions are film regions, it is determined that film-originated video covers the entire screen (step S1305). If there is a region which is not a film region, in step S1306 a region which has been determined not to be a film region is subdivided in the next field or frame, and film detection (film-originated video detection) is performed in the sub-regions. In step S1307, based on the result of step S1306, it is determined whether or not there is a film region. The determination of step S1307 is repeatedly performed until it is determined that none of sub-regions is a film region. If it is determined that none of sub-regions is a film region, regions located on the left and right of or above and below the non-film-originated video region are added to the non-film-originated video region in the next field or frame, and film-originated video detection is performed (step S1308). In step S1309, based on the result of step S1308, it is determined whether or not there is a film region. If it is determined that none of the regions is a film region, a non-film-originated video region is determined (step S1310). If there is a film region, in step S1311 a region which has been determined not to be a film region is subdivided in the next field or frame, and film detection (film-originated video detection) is performed in the resulting sub-regions. In step S1312, based on the result of step S1311, it is determined whether or not there is a film region. The determination of step S1312 is repeatedly performed in a plurality of fields or frames until it is determined that none of sub-regions is a film region. If it is determined that none of sub-regions is a film region, a non-film-originated video region is determined (step S1313), and the process is ended.

### Twelfth Embodiment

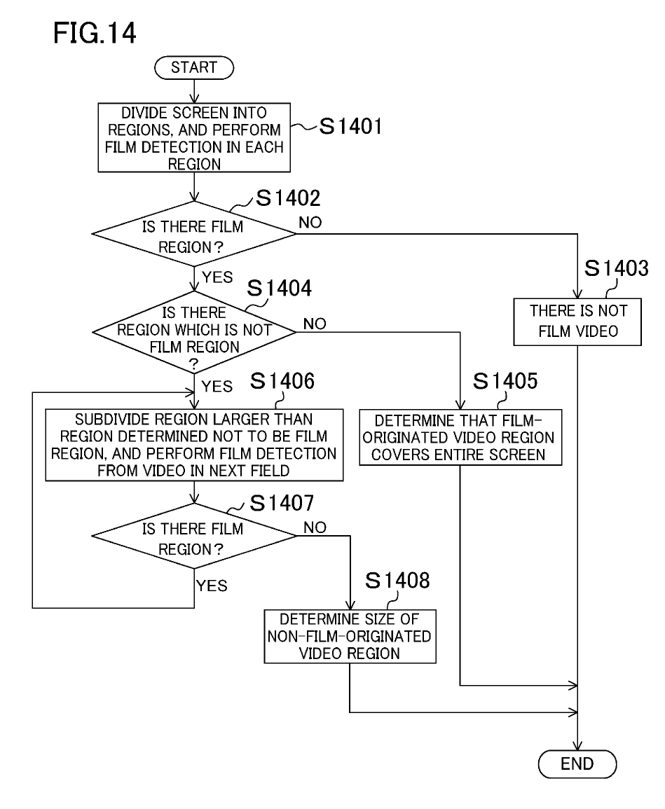

FIG. 14 is a flowchart showing a film-originated video region detection method according to a twelfth embodiment of the present disclosure. In FIG. 14, in step S1401, film detection (detection of film-originated video) is performed on an input video signal in each of a plurality of regions into which a screen is divided. In step S1402, based on the detection result, it is determined whether or not there is a film region. If it is determined that there is not a film region, it is determined that there is not film-originated video (step S1403). If it is determined that there is film-originated video, it is determined whether or not there is a region which is not a film region in step S1404. If it is determined that all the regions are film regions, it is determined that film-originated video covers the entire screen (step S1405). If there is a region which is not a film region, in step S1406 a periphery of a region which has been determined not to be a film region is expanded in the next field or frame, the expanded region is subdivided, and film detection (film-originated video detection) is performed in the sub-regions. In step S1407, based on the result of step S1406, it is determined whether or not there is a film region. The determination of step S1407 is repeatedly performed in a plurality of fields or frames until it is determined that none of sub-regions is a film region. If it is determined that none of sub-regions is a film region, a non-film-originated video region is determined (step S1408), and the process is ended.

As described above, the film-originated video region detection method of the present disclosure which detects a film-originated video region is useful for television sets, as a video processing method which changes processes or settings of interlaced-to-progressive scan conversion, frame rate conversion, noise reduction, contour correction, etc. based on an input video signal.

What is claimed is:

1. A method for detecting a film-originated video region comprising:
a first film detection step of performing film-originated video detection on an input video signal in each of regions into which an entire screen is divided;
a first region determination step of determining a film-originated video region based on a result of the first film detection step;
a second film detection step of performing film-originated video detection in each of sub-regions into which a region which has been determined to be a film-originated video region in the first region determination step is subdivided; and
a second region determination step of determining a film-originated video region based on a result of the second film detection step,
wherein
a film-originated video region is specified and detected by repeatedly performing a similar film detection step and region determination step m times, where m is an integer.

2. The method of claim 1, further comprising:
a region adjustment step of, after the film detection step and the region determination step are repeatedly performed m times, adding regions located on the left and right of or above and below a region in which film-originated video detection is to be performed to the region in which film-originated video detection is to be performed, and repeating a similar film detection step and region determination step to adjust a boundary portion.

3. A method for detecting a film-originated video region comprising:
a first film detection step of performing film-originated video detection on an input video signal in each of regions into which an entire screen is divided;
a first region determination step of determining a film-originated video region based on a result of the first film detection step;
a second film detection step of performing film-originated video detection in each of sub-regions into which a region larger than a region which has been determined to be a film-originated video region in the first region determination step is subdivided; and
a second region determination step of determining a film-originated video region based on a result of the second film detection step,
wherein
a film-originated video region is specified and detected by repeatedly performing a similar film detection step and region determination step m times, where m is an integer.

4. A method for detecting a film-originated video region comprising:
a first film detection step of performing film-originated video detection on an input video signal in each of regions into which an entire screen is divided;
a first region determination step of determining a film-originated video region based on a result of the first film detection step;
a second film detection step of performing film-originated video detection in each of sub-regions into which a region which has been determined to be a film-originated video region in the first region determination step is subdivided in the next field or frame; and
a second region determination step of determining a film-originated video region based on a result of the second film detection step,
wherein
a film-originated video region is specified and detected by repeatedly performing a similar film detection step and region determination step over a plurality of fields or frames m times, where m is an integer.

5. The method of claim 4, further comprising:
a region adjustment step of, after the film detection step and the region determination step are repeatedly performed over a plurality of fields or frames m times, adding regions located on the left and right of or above and below a region in which film-originated video detection is to be performed to the region in which film-originated video detection is to be performed, and repeating a similar film detection step and region determination step to adjust a boundary portion.

6. A method for detecting a film-originated video region comprising:
a first film detection step of performing film-originated video detection on an input video signal in each of regions into which an entire screen is divided;
a first region determination step of determining a film-originated video region based on a result of the first film detection step;
a second film detection step of performing film-originated video detection in each of sub-regions into which a region larger than a region which has been determined to be a film-originated video region in the first region determination step is subdivided in the next field or frame; and
a second region determination step of determining a film-originated video region based on a result of the second film detection step,
wherein
a film-originated video region is specified and detected by repeatedly performing a similar film detection step and region determination step over a plurality of fields or frames m times, where m is an integer.

7. A method for detecting a film-originated video region comprising:
a first film detection step of performing film-originated video detection on an input video signal in each of regions into which an entire screen is divided;
a first region determination step of determining a non-film-originated video region based on a result of the first film detection step;
a second film detection step of performing film-originated video detection in each of sub-regions into which a region which has been determined to be a non-film-originated video region in the first region determination step is subdivided; and
a second region determination step of determining a non-film-originated video region based on a result of the second film detection step,
wherein
a film-originated video region is detected by specifying a non-film-originated video region by repeatedly performing a similar film detection step and region determination step m times, where m is an integer.

8. The method of claim 7, further comprising:
a region adjustment step of, after the film detection step and the region determination step are repeatedly performed m times, adding regions located on the left and right of or above and below a region in which film-originated video detection is to be performed to the region in which film-originated video detection is to be performed, and repeating a similar film detection step and region determination step to adjust a boundary portion.

9. A method for detecting a film-originated video region comprising:
a first film detection step of performing film-originated video detection on an input video signal in each of regions into which an entire screen is divided;
a first region determination step of determining a non-film-originated video region based on a result of the first film detection step;
a second film detection step of performing film-originated video detection in each of sub-regions into which a region larger than a region which has been determined to be a non-film-originated video region in the first region determination step is subdivided; and
a second region determination step of determining a non-film-originated video region based on a result of the second film detection step,
wherein
a film-originated video region is detected by specifying a non-film-originated video region by repeatedly performing a similar film detection step and region determination step m times, where m is an integer.

10. A method for detecting a film-originated video region comprising:
a first film detection step of performing film-originated video detection on an input video signal in each of regions into which an entire screen is divided;
a first region determination step of determining a non-film-originated video region based on a result of the first film detection step;
a second film detection step of performing film-originated video detection in each of sub-regions into which a region which has been determined to be a non-film-originated video region in the first region determination step is subdivided in the next field or frame; and
a second region determination step of determining a non-film-originated video region based on a result of the second film detection step,
wherein
a film-originated video region is detected by specifying a non-film-originated video region by repeatedly performing a similar film detection step and region determination step over a plurality of fields or frames m times, where m is an integer.

11. The method of claim 10, further comprising:
a region adjustment step of, after the film detection step and the region determination step are repeatedly performed over a plurality of fields or frames m times, adding regions located on the left and right of or above and below a region in which film-originated video detection is to be performed to the region in which film-originated video detection is to be performed, and repeating a similar film detection step and region determination step to adjust a boundary portion.

12. A method for detecting a film-originated video region comprising:
a first film detection step of performing film-originated video detection on an input video signal in each of regions into which an entire screen is divided;
a first region determination step of determining a non-film-originated video region based on a result of the first film detection step;
a second film detection step of performing film-originated video detection in each of sub-regions into which a region larger than a region which has been determined to be a non-film-originated video region in the first region determination step is subdivided in the next field or frame; and
a second region determination step of determining a non-film-originated video region based on a result of the second film detection step,
wherein
a film-originated video region is detected by specifying a non-film-originated video region by repeatedly performing a similar film detection step and region determination step over a plurality of fields or frames m times, where m is an integer.
